(19) United States
(12) Patent Application Publication
(10) Pub. No.: US 2014/0049545 A1
(43) Pub. Date: Feb. 20, 2014

(54) METHOD AND SYSTEM FOR OPTIMIZING UTILITY COST

(71) Applicants: Marc Karl Losee, Woodstock, GA (US); Jerry Steven Massey, Lawrenceville, GA (US); Vernon Meadows, Lilburn, GA (US); Kamal Kumar Arvind, Atlanta, GA (US)

(72) Inventors: Marc Karl Losee, Woodstock, GA (US); Jerry Steven Massey, Lawrenceville, GA (US); Vernon Meadows, Lilburn, GA (US); Kamal Kumar Arvind, Atlanta, GA (US)

(73) Assignee: General Electric Company

(21) Appl. No.: 13/587,105

(22) Filed: Aug. 16, 2012

(51) Int. Cl. G06Q 50/06; G06T 11/20

(52) U.S. Cl. 345/440; 705/412

(57) ABSTRACT

One embodiment of a method for optimizing utility cost comprises receiving a rating for at least one device comprising at least utility service usage information for the at least one device; receiving a desired time of use for the at least one device; receiving utility rate information comprising cost information for the utility service at various times over a defined time period; determining a total cost to use the at least one device at the desired time of use based on the utility service usage information for the at least one device and the utility rate information at the desired time of use; and determining an economical cost to use the at least one device based on the utility service usage information for the at least one device and the cost information for the utility service at various times over the defined time period.

### BACKGROUND OF THE INVENTION

In response to increasing fuel costs, ever-increasing costs of power generation, ever-increasing demand for energy, and safety concerns about nuclear generation, utilities are looking for alternative means to control electrical consumption. Because utilities must design their systems to provide energy to users at peak demand, which may only occur once or just a few times annually, utilities desire to reduce or “level off” peak demand. In an effort to accomplish this goal, utilities have adopted dynamic pricing structures such that the utility service costs more during peak times of usage and costs less during times of less usage. Pricing structures for some utility services can vary widely over a 24-hour period or any other defined time period when dynamic pricing is employed. As an example, some utilities are going with different rate of utilities for different hour of the day or month of the year. Generally these variable rates will include three types of rate, peak price, average price and low price. Generally the peak price is much more than the low price. The three prices are to encourage user to receive service from the utilities in a certain pattern which fits with the generation and demand pattern of the utility. As an example, the peak price is to discourage customers from using service during higher demand period.

When a customer enrolls for these variable pricing schemes, he/she receives a notification about the current price from the utility. These pricing signals can be sent to the meter, a computer, a home energy manager (HEM), and the like. Utility pricing information can be sent via any communication medium the customer has opted for, i.e. Internet (wired and/or wireless), advanced metering infrastructure (AMI), SMS, email, etc. Pricing information can generally be stored in memory associated with the meter, computer, HEM, and the like. The customer is charged based on the current price for usage.

Because pricing information may vary over the defined time period, the customer may not be aware of the current price to use a device such as a washing machine, dishwasher, air conditioner, water heater, and the like. If the customer were aware of the current cost to use one or more devices, then the customer may postpone or reschedule the use of the one or more devices to a time period when the cost is less. This not only saves the customer money, but may reduce generation and facility costs incurred by the utilities to meet peak demands.

Described herein are embodiments of methods and systems for providing an instant cost analysis to the customer before he/she decides to use any equipment or appliance that overcome challenges in the art, some of which are described herein.

### BRIEF DESCRIPTION OF THE INVENTION

Disclosed and described herein are embodiments of systems and methods for providing an instant cost analysis to the customer before he/she decides to use any equipment or appliance. Embodiments of the present invention may be located in the HEM, a computer, or any device/appliance that may be in communication with the meter and/or the utility to receive the utility prices. As an example, embodiments of the present invention may be located in a customer laptop device when the laptop is operably connected to utility to receive the price of the utility.

In one aspect, methods are described. One embodiment of a method for optimizing utility cost comprises receiving a rating for at least one device; wherein the rating comprises at least utility service usage information for the at least one device; receiving a desired time of use for the at least one device; receiving utility rate information, wherein the utility rate information comprises cost information for the utility service at various times over a defined time period; determining a total cost to use the at least one device at the desired time of use based on the utility service usage information for the at least one device and the utility rate information at the desired time of use; and determining an economical cost to use the at least one device based on the utility service usage information for the at least one device and the cost information for the utility service at various times over the defined time period, wherein the economical cost of use is less than or equal to the total cost of use.

Another embodiment of a method for optimizing utility cost comprises receiving a rating for at least one device; wherein the rating comprises at least utility service usage information for the at least one device; graphically displaying on an interactive display utility rate information, wherein the utility rate information comprises cost information for the utility service at various times over a defined time period; receiving a selection for a desired time of use from the interactive display for using the at least one device; and determining a total cost to use the at least one device at the desired time of use based on the utility service usage information for the at least one device and the utility rate information at the desired time of use and displaying the total cost to use on the interactive display.

In another aspect, systems are described. On embodiment of a system for optimizing utility cost comprises a memory and a processor operably connected with the memory. The processor is configured to receive a rating for at least one device; wherein the rating comprises at least utility service usage information for the at least one device; receive a desired time of use for the at least one device and store the rating and the desired time of use in the memory; receive utility rate information, wherein the utility rate information comprises cost information for the utility service at various times over a defined time period and store the utility rate information in the memory; determine a total cost to use the at least one device at the desired time of use based on the utility service usage information for the at least one device and the utility rate information at the desired time of use, wherein the utility service usage information for the at least one device and the utility rate information at the desired time of use is retrieved from the memory; and determine an economical cost to use the at least one device based on the utility service usage information for the at least one device and the cost information for the utility service at various times over the defined time period, wherein the economical cost of use is less than or equal to the total cost of use and wherein the utility service usage information for the at least one device and the utility rate information at the desired time of use is retrieved from the memory.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an illustration of one type of system that would benefit from embodiments of the present invention;

FIG. 2 is an overview block diagram of a system that can be used to implement embodiments of the present invention;

FIG. 3 is an exemplary graph illustrating a defined time period and varying cost information for a utility service over the time period;

FIG. 4 illustrates an embodiment of a system for optimizing utility cost;

FIG. 5 is a flowchart illustrating an embodiment of a method of the present invention;

FIG. 6 is a flowchart illustrating another embodiment of a method of the present invention; and

FIG. 7 is a block diagram illustrating an exemplary operating environment for performing the disclosed methods.

### DETAILED DESCRIPTION OF THE INVENTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

Disclosed and described herein are embodiments of systems and methods for providing an instant cost analysis to the customer before he/she decides to use any equipment or appliance. Embodiments of the present invention may be located in the HEM, a computer, or any device/appliance that may be in communication with the meter and/or the utility to receive the utility prices. As an example, embodiments of the present invention may be located in a customer laptop device when the laptop is operably connected to utility to receive the price of the utility.

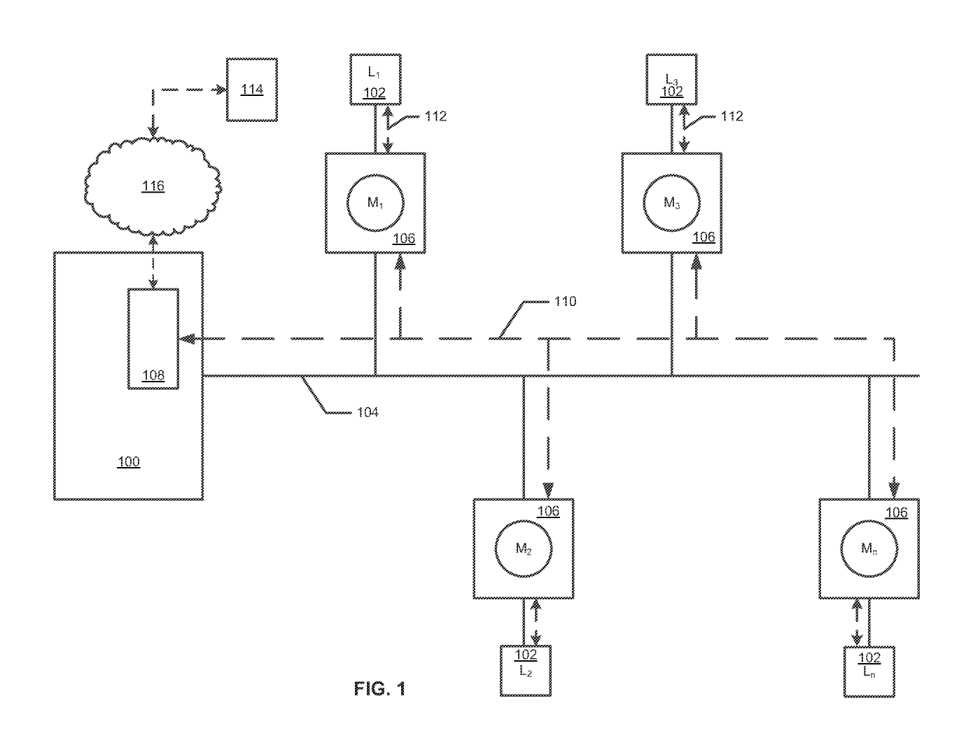

Referring to FIG. 1, an illustration of one type of system that would benefit from embodiments of the present invention is provided. FIG. 1 is a single-line block diagram of a section of an exemplary utility distribution system such as, for example, an electric distribution system. As shown in FIG. 1, a utility service is delivered by a utility provider 100 to various loads L₁-Lₙ 102 through a distribution system 104. In one aspect, the utility service provided can be electric power. Though shown in FIG. 1 as a single-line diagram, it is to be appreciated that the distribution system 104 can be comprised of single-phase and/or poly-phase components and be of varying voltage levels. Consumption and demand by the loads 102 can be measured at the load locations by meters M₁-Mₙ 106. If an electric meter, the meters 106 can be single-phase or poly-phase electric meters, as known to one of ordinary skill in the art, depending upon the load 102. For example, the load can be single-phase and therefore the meter 106 can be single phase. Single-phase loads can be connected to different phases (e.g., phase A, phase B or phase C) of the distribution system 104. Similarly, for example, the load 102 can be a poly-phase load such as a three-phase load and the meter 106 can be a three-phase meter that meters the three phases serving the load 102.

In one aspect, the electric meter 106 is a smart meter as described herein and as known to one of ordinary skill in the art. Hereinafter, the specification will refer to the meter 106 as a “meter,” “electric meter,” and/or “smart meter,” where the terms can be used interchangeably. One non-limiting example of a smart meter is the GE I210+c meter as available from General Electric Company (“GE”) (Schenectady, N.Y.). Another non-limiting example of a smart meter is the GE SM3000 meter as also available from GE. While consumption or demand information is used by the utility provider 100 primarily for billing the consumer, it also can be used for other purposes including planning and profiling the utility distribution system. In some instances, utility providers 100 desire to electronically communicate with the meters 106 for numerous purposes including scheduling disconnection or connection of utility services to the loads 102, automatic meter reading (AMR), load shedding and load control, automatic distribution and smart-grid applications, outage reporting, providing additional services such as Internet, video, and audio, etc. In many of these instances, the meters 106 can be configured to communicate with one or more computing devices 108 through a communications network 110, which can be wired, wireless or a combination of wired and wireless, as known to one of ordinary skill in the art. In one aspect, the network 110 is an advanced metering infrastructure (AMI) network. AMI refers to systems that measure, collect and analyze energy usage, and interact with advanced devices such as electricity meters, gas meters, water meters, and the like through various communication media either on request (on-demand) or on pre-defined schedules. This infrastructure includes hardware, software, communications, consumer energy displays and controllers, customer associated systems, meter data management (MDM) software, supplier and network distribution business systems, and the like. The network 110 between the measurement devices (e.g., meters 106) and business systems allows collection and distribution of information to customers, suppliers, utility companies and service providers. This enables these businesses to either participate in, or provide, demand response solutions, products and services. By providing information to customers, the system assists a change in energy usage from their normal consumption patterns, either in response to changes in price or as incentives designed to encourage lower energy usage use at times of peak-demand periods or higher wholesale prices or during periods of low operational systems reliability. In one aspect, the network 110 comprises at least a portion of a smart grid network. In one aspect, the network 110 utilizes one or more of one or more of a WPAN (e.g., ZigBee, Bluetooth), LAN/WLAN (e.g., 802.11n, microwave, laser, etc.), WMAN (e.g., WiMAX, etc.), WAN/WWAN (e.g., UMTS, GPRS, EDGE, CDMA, GSM, CDPD, Mobitex, HSDPA, HSUPA, 3G, etc.), RS232, USB, Firewire, Ethernet, wireless USB, cellular, OpenHAN, power line carrier (PLC), broadband over power lines (BPL), and the like.

Electrical loads 102 at metered locations can have rating information. Generally, rating information comprises utility service usage information. For example, the electrical devices 102 may have an associated kilowatt (kW) rating that describes the device's 102 consumption of electrical energy. Such electrical devices can include, for example, one or more of a heating, ventilation and air conditioning (HVAC) unit, a water heater, lighting, a dish washer, a refrigerator, a washing machine, a dryer, an electric stove or oven, a microwave oven, and the like. In some instances, the devices can be “smart” devices and include a processor and network interface capabilities. In some instances, the utility 100 desires to communicate with one or more “smart” electrical devices 102 at a metered location. In one aspect, the network 110 can be used by the utility to communicate with the one or more electrical devices 102. For example, a utility may desire to receive utility service usage information from a “smart” device that has been programmed with such information. Such information may be stored in the meter 106 and/or in the computing device. In various instances, the utility 100 can communicate with the “smart” electrical devices 102 by use of network 110 that can comprise all or part of an AMI (as described herein), a smart-grid implementation, an Internet connection, or combinations thereof. The network 110 media can be wired (including fiber optic), wireless, or combinations thereof. In one aspect, the network 110 communicates with a meter 106, such as a smart meter, which in turn communicates 112 either wirelessly or through a wired connection with one or more “smart” electrical devices 102 at the metered location. In other instances, the network 110 may communicate directly with the one or more “smart” electrical devices 102 using, for example, the Internet, cellular telephone, wired telephone connections, wired cable television connections, and the like.

Computing device 108, described in greater detail herein, can be used to control utility 100 functions such as meter reading, receiving rating information for at least one device 102, wherein the rating information comprises at least utility service usage information for the at least one device 102 and desired time of use for the at least one device 102, store the rating information in a memory associated with the computing device 108, sending the rating information and utility rate information to the meter 106, “smart” electrical devices 102, a home energy manager (HEM), another computing device, and the like. In one aspect, computing device 108 may be connected with other systems 114 through one or more other networks 116.

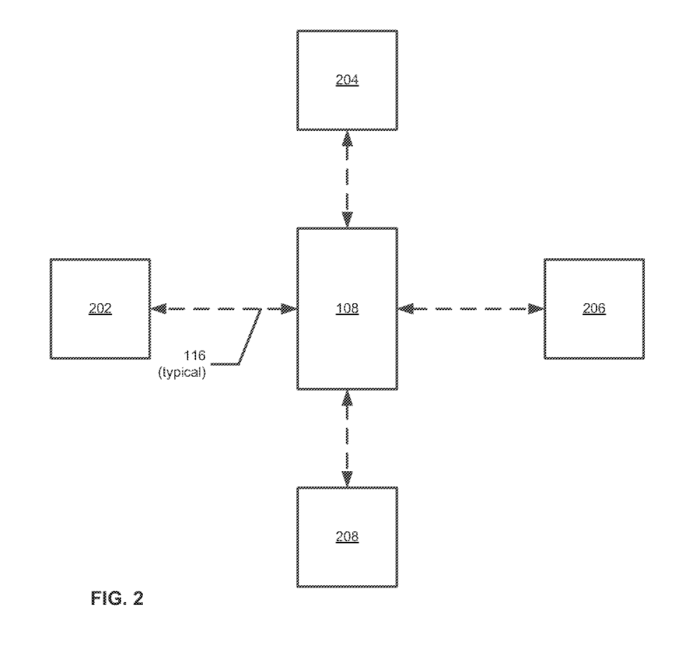

FIG. 2 is an overview block diagram of a system that can be used to implement embodiments of the present invention. For example, computing device 108, which can be used to implement aspects of the present invention, can be interconnected with or also be used to implement all or parts of one or more other systems such as, for example, a HEM 202, a smart meter 204, another computing device 206, a smart appliance, and the like. Such systems, if not hosted on computing device 108, can be interconnected with computing device 108 through one or more networks 116, which can be comprised of wired (including fiber optic) or wireless media, and combinations thereof, and using any of a number of present or future-developed protocols. Information can be passed to and from computing device 108 and the various systems 202, 204, 206, 208. In other aspects, information from one or more of systems 202, 204, 206, 208 can be manually input into computing device 108 in order to facilitate implementation of embodiments of the present invention. Furthermore, computing device 108 can be interconnected with various utility devices such as meters 106 through network 110, which can be an AMI network, as described herein.

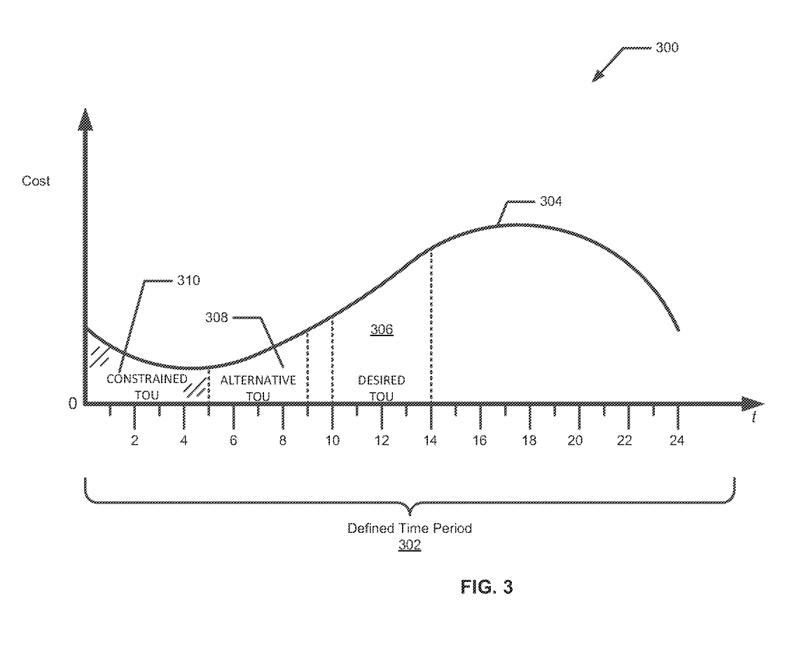

FIG. 3 is an exemplary graph 300 illustrating a defined time period 302 and varying cost information for a utility service over the time period 302. The time period 302 is initially not fixed and can be set as desired. For example, the defined time period 302 can comprise establishing a time period of one hour, one day, one week, one month, one year, two years, five years, ten years, 20 years, etc., or any period of time therebetween. The curve 304 shown in FIG. 3 represents utility rate information, which can be comprised of the cost of the utility service at various times over the defined time period 302. Generally, the cost curve 304 directly corresponds with the demand for the utility service. In other words, the cost for the utility service is generally the greatest when the demand for the utility service is the greatest. As shown in FIG. 3, a user of the utility service has identified a time period as a desired time of use 306. This desired time of use 306 is the preferred time period for the user to use the utility service for one or more devices. For example, the user may pre-set a washing machine and the desired time period to have it run is between the hours of 10:00 a.m. and 2:00 p.m. The user may desire that the device come on at 10:00 a.m. or later (but before 2:00 p.m.) and run for a specified period of time (but not past 2:00 p.m.), or until completion of the process performed by the device (i.e., cooking, washing, cooling, heating, etc.). The user may enter this information in various ways. For example, the user may access a website that interfaces with a computing device such as computing device 108 and enter information about the preferred time of use for various devices. As another example, the device (i.e., washing machine, water heater, etc.) may be configured with a mechanism such as a keyboard, touch screen, etc., for entering the desired time of use 306, which can then be transmitted via a network such as the Internet or an AMI, the network being wireless, wired or combinations thereof, to a computing device such as computing device 108. In another aspect, the user may be provided with a graphical display on an interactive display that illustrates the utility rate information over the defined time period 302 and the user can selectively choose the desired time of use 306. The interactive display may be associated with the device, a meter 106, or a computing device such as a laptop computer.

In one aspect, once the desired time of use 306 information for one or more devices is received, the computing device such as computing device 108 determines an alternative time of use 308 for the one or more devices. In one aspect, this is performed using rating information for each of the one or more devices. Rating information can comprise utility service usage information for at least one device. For example, if the utility service is electrical energy, then each of the one or more devices (e.g., washing machine, dryer, microwave, oven, water heater, air conditioner, etc.) has an electrical consumption rating such as in kW. In one aspect, the user enters or has previously entered the rating information into a database similar to the way that the desired time of use 306 information was entered for a device. In another aspect, the device may be a “smart” device such as a smart appliance and the rating information may be transmitted to a computing device such as computing device 108 over a network such as the Internet, AMI, and the like. In another aspect, the rating information may come from device vendors where such vendors have systems 114 in communication with the computing device 108 via networks 116. The computing device such as computing device 108 uses the desired time of use and the utility service usage information to determine a total cost to use the at least one device at the desired time of use 306. The computing device such as computing device 108 then computes an economical cost to use 308 based on the utility service usage information and the cost information 304 for the utility service at various times over the defined time period 302. In effect, the computing device such as computing device 108 seeks to minimize the cost to operate the at least one device in order to find the economical cost to use that at least one device. The economical cost to use is less than or equal to the total cost to use. The time period of the defined time period 302 that corresponds to the economical cost to use the at least one device can be proposed to the user as an alternative time of use 308.

In one aspect, the economical time of use 308 can be subject to constraints. For example, the user may desire that the one or more devices are not in use during a constrained time of use 310. The user may enter one or more period of constrained time of use 310 for each of the one or more devices in a manner similar the way in which the desired time of use 306 was entered. As with the desired time of use 306 and the device rating information, once entered, the constrained time(s) of use 310 can be stored in a memory associated with a computing device such as computing device 108. The computing device such as computing device 108 is precluded from using the utility cost information 304 during the constrained time periods 310 for determining the economical cost to use. Therefore, the alternative time of use 308 cannot be any portion of any time period that has been identified as a constrained time of use 310, even though the economical cost to use may be at its lowest during at least a portion of the constrained time of use 310. For example, a mother with young children may not want the noise associated with a washing machine or dryer being operated from midnight until 5:00 a.m. in the morning, even though that may be the most economical time to operate the washer and/or dryer.

In another aspect, once the desired time of use 306 information for one or more devices is received, the computing device such as computing device 108 determines the alternative time of use 308 for the one or more devices without receiving the rating information for the one or more devices. For example, referring to the curve 304 of FIG. 3 the computing device such as computing device 108 can determine that it would be more economical to operate any device that uses the utility service between the time period of 5 and 9 than it would be to operate the device between the time period of 10 and 14 because the cost of the utility service is less during the 5 to 9 time period than it is during the 10 to 14 time period. The most economical time period to operate any of the one or more devices that use the utility service would be the time period between 2 and 6, but most of this time period is under a constraint 310, thus the at least one device cannot begin operating until the time period starting at 5.

Therefore, as can be seen by FIG. 3, the technical effect of embodiments of the present invention is to schedule the use of a utility service by one or more devices at periods of use that may be more economical than the desired period of use, subject to any constraints on the use of each of the one or more devices.

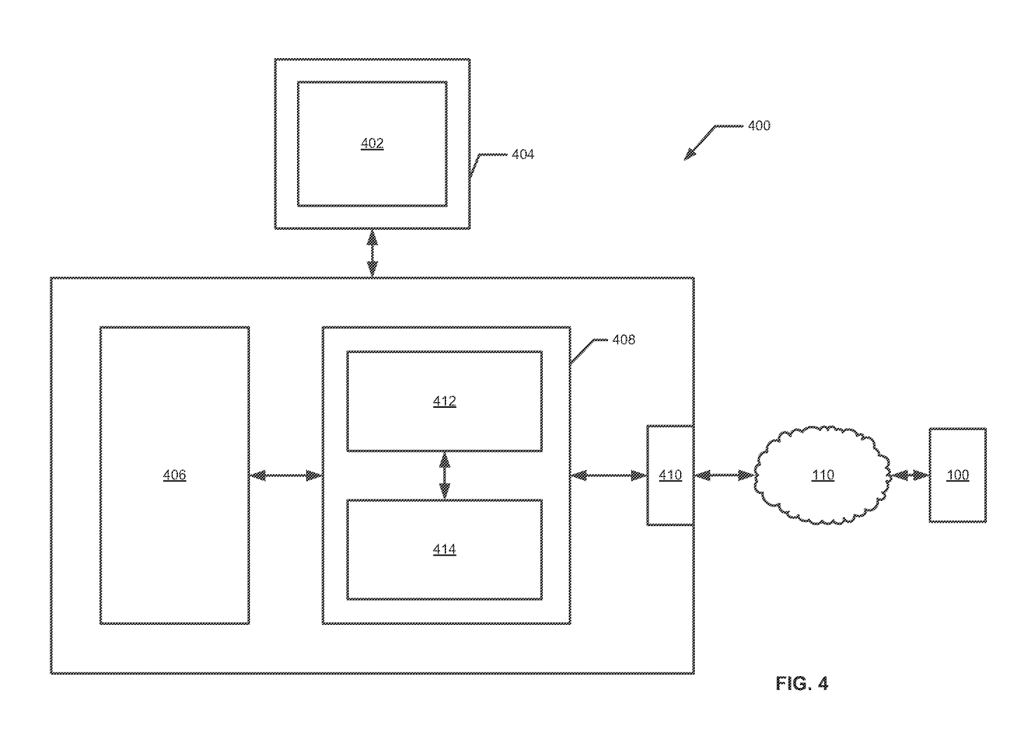

FIG. 4 illustrates an embodiment of a system 400 for optimizing utility cost. The shown embodiment provides an instant cost analysis to a customer before he/she decides to use any equipment or appliance that requires the utility service. The illustrated embodiment of a system 400 may be located in the home energy manager (HEM) or any device/appliance which may be connected to the meter/utility to receive utility price information. As an example, embodiments of the system 400 may be located in a customer laptop device when laptop is able to receive price information for the utility service.

The embodiment of a system 400 generally is comprised of a processor 406, a memory 408 operably connected with the processor 406, a network interface 410 and three modules. The first module 402 can be a User Interface (UI) for the customer to enter and receive the rating of the devices which he/she is going to use and any time of use (TOU) preferences. This module 402 may store the rating of the devices that the customer enters so that this information does not have to be entered into the system 400 again and again. The rating can include, for example, a kilowatt rating (kW) of the devices and the possible duration/time of use. In one aspect, the first module 402 can be located in or associated with a display device 404 such as, for example, an interactive display. The UI module 402 can also be used to enter and store constraints on the time of use of one or more devices. Such constraints define time periods when the user desires a device not be provided utility service.

The second module 412 comprises a module for interacting, using the network interface 410, with the utility to receive and store utility rate information. The second module 412 allows the system 400 to interact with the utility 100 over a network 110. Generally, the rate information comprises cost information for the utility service at various times over a defined time period. This module 412 can further store historical rate information for an extended time period (e.g., past several months). For example, this module 412 can receive and store in the memory 408 rate information for different times of the day and different days of the month.

The third module 414 comprises a module for determining a total cost of the utility service when the customer desires the use the equipment. The third module 414 can be configured to fetch the information about the devices the customer is going to use and the time of use from the first module 402. The third module 414 can further fetch the current utility rate and the historical utility rate information from the second module 412. The third module 414 can calculate the total estimated current cost of using the devices. This can be calculated using the current rate and the estimated or desired time of use. The third module 414 can further calculate an alternative economical cost for using the equipment. The economical cost can be calculated by determining a time window within the defined time period by using the historical rate information of the utility. Furthermore, the third module 414 can also calculate the lowest economical cost for using the equipment for the month by using the historical rate of the utility for that month. Determining a time period for lowest economical cost, regardless of the defined time period chosen, is subject to the constraints entered and stored using the first module 402. Once determined, lowest economical cost information can be provided to the customer using the display 404.

In another embodiment of a system for optimizing utility cost, the first module 402 can cause the utility rate information received by the second module 412 to be graphically displayed on the interactive display 404, and the customer can selectively choose, using the interactive display 404, a desired time of use for using the at least one device. The third module 414 can then determine a total cost to use the at least one device at the desired time of use based on the utility service usage information for the at least one device and the utility rate information at the desired time of use and cause the determined total cost to use to be displayed on the interactive display 404.

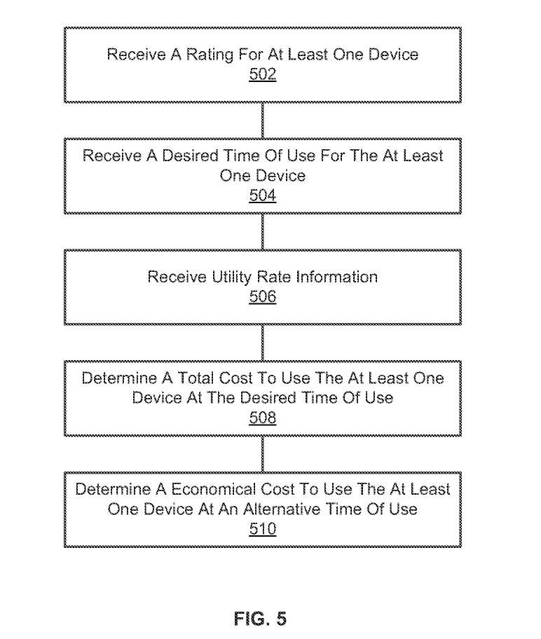

FIG. 5 is a flowchart illustrating an embodiment of a method of the present invention. Such a method can be implemented on a computing system such as computing system 108 and/or system 400 of FIG. 4. As shown in FIG. 5, at step 502, a rating for at least one device is received. Generally, the rating comprises at least utility service usage information for the at least one device such as kW consumed when operating at various load levels, cubic feet of gas consumed when operating at various load levels, gallons of water or fuel used or consumed when operating at various load levels, and the like. Generally, the rating information is received by a computing device such as computing device 108 and is input by a user of the device, transmitted from the device itself, received from a vendor of the device, or the like. At step 504, a desired time of use for at least one of the one or more devices can be received. Generally, the desired time of use is input by a customer of the utility. In one aspect, constraints on the time of use can also be received. Generally, the constraints are time periods that a user does not want one or more of the devices to operate. At step 506, utility rate information is received, wherein the utility rate information comprises cost information for the utility service at various times over a defined time period. The time period can be of any desired duration. For example, the defined time period can be a time period of one hour, one day, one week, one month, one year, two years, five years, ten years, etc., or any period of time therebetween. The cost information for the utility service can be, for example, dollars per kW, dollars per cubic foot, dollars per gallon, and the like, though it is to be appreciated that any form of currency is contemplated within the scope of embodiments of the present invention. At step 508, a total cost to use the at least one device at the desired time of use based on the utility service usage information for the at least one device and the utility rate information at the desired time of use is determined. Generally, the cost information for the utility service at the time of desired use is multiplied by the utility service usage information for the at least one device to determine the total cost to use the at least one device at the desired time of use. At step 510, an economical cost to use the at least one device is determined based on the utility service usage information for the at least one device and the cost information for the utility service at various times over the defined time period, wherein the economical cost of use is less than or equal to the total cost of use. Generally, this involved determining a time period that is not constrained for operating the at least one device when the cost for the utility service is less than the cost for the utility service at the desired time of use. In some instances, if the desired time or use is at the lowest available cost time period of the utility service, the economical cost of use may be the same as the total cost of use. If the time period of the economical cost of use is not the same as the time period of the desired time of use, then an indication of an alternative time of use during the defined time period of the at least one device that corresponds to the economical cost to use the at least one device can be provided to the customer.

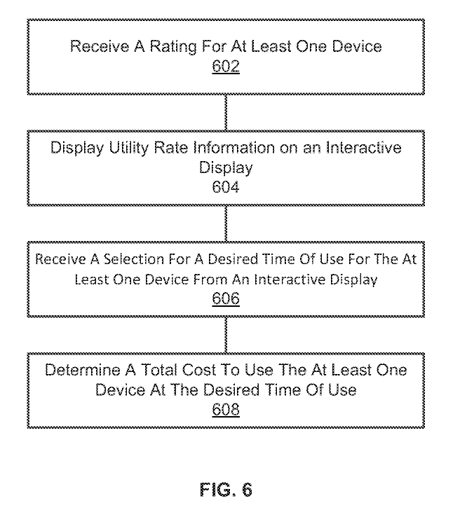

FIG. 6 is a flowchart illustrating an alternate embodiment of a method of the present invention. Such a method can be implemented on a computing system such as computing system 108 and/or system 400 of FIG. 4. As shown in FIG. 6, at step 602, a rating for at least one device is received. Generally, the rating comprises at least utility service usage information for the at least one device such as kW consumed when operating at various load levels, cubic feet of gas consumed when operating at various load levels, gallons of water or fuel used or consumed when operating at various load levels, and the like. Generally, the rating information is received by a computing device such as computing device 108 and is input by a user of the device, transmitted from the device itself, received from a vendor of the device, or the like. At step 604, utility rate information can be graphically displayed on an interactive display, wherein the utility rate information comprises cost information for the utility service at various times over a defined time period. For example, the cost versus time curve for the utility service as shown in FIG. 3 may be graphically displayed on the interactive display. At step 606, a selection for a desired time of use can be received from the interactive display for using the at least one device. Generally, this selection is made by the utility customer and the user of the device. In one aspect, constraints on the time of use can also be received from the interactive display. Generally, the constraints are time periods that a user does not want one or more of the devices to operate. At step 608, a total cost to use the at least one device at the desired time of use based on the utility service usage information for the at least one device and the utility rate information at the desired time of use can be determined and displayed on the interactive display. Therefore, the user may select another time period to use the device to reduce the cost or consciously decide to pay a higher rate for the utility service at the desired time of use. In one aspect, an economical cost to use the at least one device can be determined based on the utility service usage information for the at least one device and the cost information for the utility service at various times over the defined time period, wherein the economical cost of use is less than or equal to the total cost of use and displaying the economical cost to use on the interactive display. Generally, this involved determining a time period that is not constrained for operating the at least one device when the cost for the utility service is less than the cost for the utility service at the desired time of use. In some instances, if the desired time or use is at the lowest available cost time period of the utility service, the economical cost of use may be the same as the total cost of use. If the time period of the economical cost of use is not the same as the time period of the desired time of use, then an indication of an alternative time of use during the defined time period of the at least one device that corresponds to the economical cost to use the at least one device can be provided to the customer.

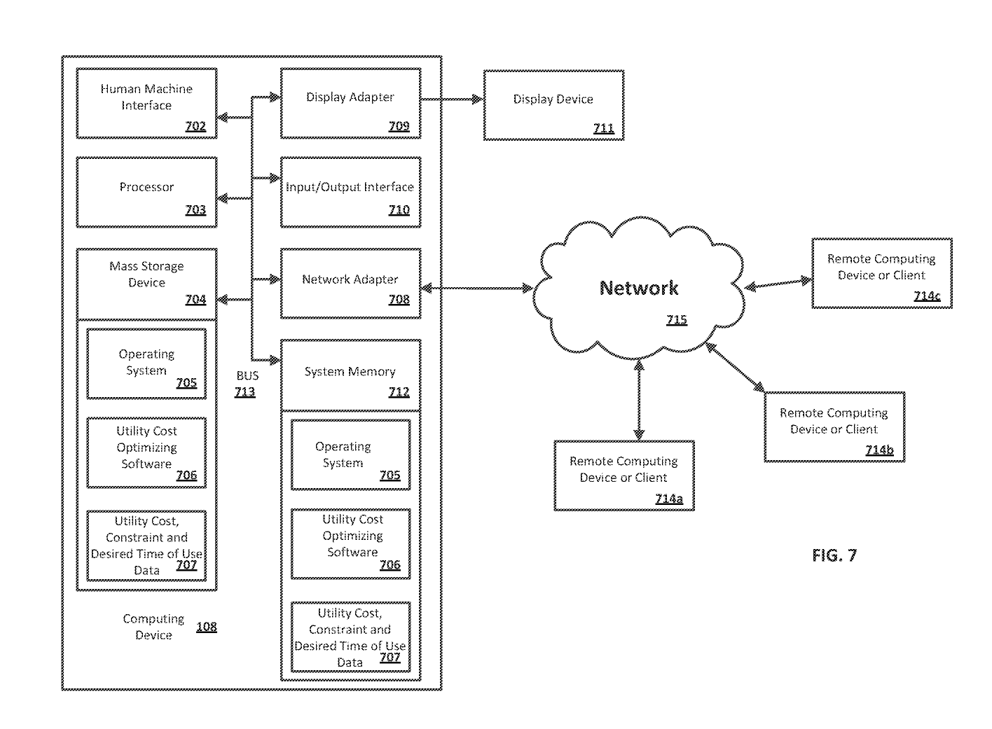

The above system has been described above as comprised of units. One skilled in the art will appreciate that this is a functional description and that software, hardware, or a combination of software and hardware can perform the respective functions. A unit, such as computing device 108, meter 106, system 400 for optimizing utility cost, etc., can be software, hardware, or a combination of software and hardware. The units can comprise the utility cost optimizing software 706 as illustrated in FIG. 7 and described below. In one exemplary aspect, the units can comprise a computing device 108 as referenced above and further described below.

FIG. 7 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, home energy managers (HEMs) and multiprocessor systems. Additional examples comprise set top boxes, programmable consumer electronics, network PCs, minicomputers, mainframe computers, smart meters, smart-grid components, SCADA masters, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a computing device 108. The components of the computing device 108 can comprise, but are not limited to, one or more processors or processing units 703, a system memory 712, and a system bus 713 that couples various system components including the processor 703 to the system memory 712. In the case of multiple processing units 703, the system can utilize parallel computing. In one aspect, the processor 703 can be configured to receive a rating for at least one device, wherein the rating comprises at least utility service usage information for the at least one device; receive a desired time of use for the at least one device and store the rating and the desired time of use in the memory 704; receive utility rate information, wherein the utility rate information comprises cost information for the utility service at various times over a defined time period and store the utility rate information in the memory; determine a total cost to use the at least one device at the desired time of use based on the utility service usage information for the at least one device and the utility rate information at the desired time of use, wherein the utility service usage information for the at least one device and the utility rate information at the desired time of use is retrieved from the memory 704; and determine an economical cost to use the at least one device based on the utility service usage information for the at least one device and the cost information for the utility service at various times over the defined time period, wherein the economical cost of use is less than or equal to the total cost of use and wherein the utility service usage information for the at least one device and the utility rate information at the desired time of use is retrieved from the memory 704. The system bus 713 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 713, and all buses specified in this description can also be implemented over a wired or wireless network connection and each of the subsystems, including the processor 703, a mass storage device 704, an operating system 705, utility cost optimizing software 706, utility cost, constraint, and desired time of use data 707, a network adapter 708, system memory 712, an Input/Output Interface 710, a display adapter 709, a display device 711, and a human machine interface 702, can be contained within one or more remote computing devices or clients 714a,b,c at physically separate locations, connected through buses of this form, in effect implementing a fully distributed system or distributed architecture.

The computing device 108 typically comprises a variety of computer readable media. Exemplary readable media can be any available media that is non-transitory and accessible by the computing device 108 and comprises, for example and not meant to be limiting, both volatile and non-volatile media, removable and non-removable media. The system memory 712 comprises computer readable media in the form of volatile memory, such as random access memory (RAM), and/or non-volatile memory, such as read only memory (ROM). The system memory 712 typically contains data such as utility cost, constraint, and desired time of use data 707 and/or program modules such as operating system 705 and utility cost optimizing software 706 that are immediately accessible to and/or are presently operated on by the processing unit 703. In one aspect, the system memory 712 contains computer executable codes sections for performing the steps of receiving a rating for at least one device, wherein the rating comprises at least utility service usage information for the at least one device; receive a desired time of use for the at least one device and store the rating and the desired time of use in the memory 704; receiving utility rate information, wherein the utility rate information comprises cost information for the utility service at various times over a defined time period and store the utility rate information in the memory; determining a total cost to use the at least one device at the desired time of use based on the utility service usage information for the at least one device and the utility rate information at the desired time of use, wherein the utility service usage information for the at least one device and the utility rate information at the desired time of use is retrieved from the memory 704; and determining an economical cost to use the at least one device based on the utility service usage information for the at least one device and the cost information for the utility service at various times over the defined time period, wherein the economical cost of use is less than or equal to the total cost of use and wherein the utility service usage information for the at least one device and the utility rate information at the desired time of use is retrieved from the memory 704.

In another aspect, the computing device 108 can also comprise other non-transitory, removable/non-removable, volatile/non-volatile computer storage media. By way of example, FIG. 7 illustrates a mass storage device 704 that can provide non-volatile storage of computer code, computer readable instructions, data structures, program modules, and other data for the computing device 108. For example and not meant to be limiting, a mass storage device 704 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 704, including by way of example, an operating system 705 and utility cost optimizing software 706. Each of the operating system 705 and utility cost optimizing software 706 (or some combination thereof) can comprise elements of the programming and the utility cost optimizing software 706. Utility cost, constraint, and desired time of use data 707 can also be stored on the mass storage device 704. Utility cost, constraint, and desired time of use data 707 can be stored in any of one or more databases known in the art. Examples of such databases comprise, DB2® (IBM Corporation, Armonk, N.Y.), Microsoft® Access, Microsoft® SQL Server, (Microsoft Corporation, Bellevue, Wash.), Oracle®, (Oracle Corporation, Redwood Shores, Calif.), mySQL, PostgreSQL, and the like. The databases can be centralized or distributed across multiple systems.

In another aspect, the user can enter commands and information into the computing device 108 via an input device (not shown). Examples of such input devices comprise, but are not limited to, a keyboard, pointing device (e.g., a “mouse”), a microphone, a joystick, a scanner, an interactive display, tactile input devices such as gloves, and other body coverings, and the like These and other input devices can be connected to the processing unit 703 via a human machine interface 702 that is coupled to the system bus 713, but can be connected by other interface and bus structures, such as a parallel port, game port, an IEEE 1394 Port (also known as a Firewire port), a serial port, or a universal serial bus (USB).

In yet another aspect, a display device 711 can also be connected to the system bus 713 via an interface, such as a display adapter 709. It is contemplated that the computing device 108 can have more than one display adapter 709 and the computing device 108 can have more than one display device 711. For example, a display device can be a monitor, an LCD (Liquid Crystal Display), or a projector. In addition to the display device 711, other output peripheral devices can comprise components such as speakers (not shown) and a printer (not shown), which can be connected to the computer 108 via Input/Output Interface 710. Any step and/or result of the methods can be output in any form to an output device. Such output can be any form of visual representation, including, but not limited to, textual, graphical, animation, audio, tactile, and the like.

The computing device 108 can operate in a networked environment using logical connections to one or more remote computing devices or clients 714a,b,c. By way of example, a remote computing device 714 can be a personal computer, portable computer, a server, a router, a network computer, a smart meter, a vendor or manufacture's computing device, smart grid components, a SCADA master, a DRMS processor, a DMS processor, a peer device or other common network node, and so on and can be in support of a system for optimizing utility cost. Logical connections between the computing device 108 and a remote computing device or client 714a,b,c can be made via a local area network (LAN) and a general wide area network (WAN). Such network connections can be through a network adapter 708. A network adapter 708 can be implemented in both wired and wireless environments. Such networking environments are conventional and commonplace in offices, enterprise-wide computer networks, intranets, and other networks 715 such as the Internet, an AMI network, or the like.

For purposes of illustration, application programs and other executable program components such as the operating system 705 are illustrated herein as discrete blocks, although it is recognized that such programs and components reside at various times in different storage components of the computing device 701, and are executed by the data processor(s) of the computer. An implementation of utility cost optimizing software 706 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

As described above and as will be appreciated by one skilled in the art, embodiments of the present invention may be configured as a system, method, or computer program product. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable non-transitory computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as the processor 406 of FIG. 4 and/or the one or more processors 703 discussed above with reference to FIG. 7, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 406 of FIG. 4 and/or the one or more processors 703 of FIG. 7) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method of optimizing utility cost comprising:
receiving, by a computing device, a rating for at least one device, wherein said rating comprises at least utility service usage information for the at least one device;
receiving, by the computing device, a desired time of use for the at least one device;
receiving, by the computing device, utility rate information, wherein said utility rate information comprises cost information for the utility service at various times over a defined time period;
determining, by the computing device, a total cost to use the at least one device at the desired time of use based on the utility service usage information for the at least one device and the utility rate information at the desired time of use; and
determining, by the computing device, an economical cost to use the at least one device based on the utility service usage information for the at least one device and the cost information for the utility service at various times over the defined time period, wherein the economical cost of use is less than or equal to the total cost of use.

2. The method of claim 1, further comprising the computing device providing an indication of an alternative time of use during the defined time period of the at least one device that corresponds to the economical cost to use the at least one device.

3. The method of claim 2, wherein the alternative time of use is at a different time during the defined time period than the desired time of use.

4. The method of claim 1, wherein the utility service comprises electricity and the rating comprises electrical consumption information for the at least one device.

5. The method of claim 1, further comprising receiving, by the computing device, one or more constraints on the time of use of the at least one device and the economical cost to use the at least one device is subject to the one or more constraints on the time of use of the at least one device.

6. The method of claim 5, wherein the one or more constraints on the time of use of the at least one device comprise periods of time during the defined time period when it is desired that the at least one device not be used.

7. A method of optimizing utility cost comprising:
receiving, by a computing device, a rating for at least one device, wherein said rating comprises at least utility service usage information for the at least one device;
graphically displaying on an interactive display utility rate information, wherein said utility rate information comprises cost information for the utility service at various times over a defined time period;
receiving, by the computing device, a selection for a desired time of use from the interactive display for using the at least one device; and
determining, by the computing device, a total cost to use the at least one device at the desired time of use based on the utility service usage information for the at least one device and the utility rate information at the desired time of use and displaying the total cost to use on the interactive display.

8. The method of claim 7, further comprising the computing device determining an economical cost to use the at least one device based on the utility service usage information for the at least one device and the cost information for the utility service at various times over the defined time period, wherein the economical cost of use is less than or equal to the total cost of use and displaying the economical cost to use on the interactive display.

9. The method of claim 8, further comprising the computing device determining an alternative time of use during the defined time period of the at least one device that corresponds to the economical cost to use the at least one device and displaying the alternative time of use on the interactive display.

10. The method of claim 9, wherein the alternative time of use is at a different time during the defined time period than the desired time of use.

11. The method of claim 9, further comprising the computing device receiving from the interactive display a selection of whether to use the at least one device during the desired time of use or during the alternative time of use.

12. The method of claim 8, further comprising the computing device receiving one or more constraints on the time of use of the at least one device and the economical cost to use the at least one device is subject to the one or more constraints on the time of use of the at least one device.

13. The method of claim 12, wherein the one or more constraints on the time of use of the at least one device comprise periods of time during the defined time period when it is desired that the at least one device not be used.

14. The method of claim 7, wherein the utility service comprises electricity and the rating comprises electrical consumption information for the at least one device.

15. A system for optimizing utility cost comprising:
a memory; and
a processor operably connected with the memory, said processor configured to:
receive a rating for at least one device, wherein said rating comprises at least utility service usage information for the at least one device and desired time of use for the at least one device and store said rating in the memory;
receive a desired time of use for the at least one device and store said desired time of use in the memory;
receive utility rate information, wherein said utility rate information comprises cost information for the utility service at various times over a defined time period and store said utility rate information in the memory;
determine a total cost to use the at least one device at the desired time of use based on the utility service usage information for the at least one device and the utility rate information at the desired time of use, wherein said utility service usage information for the at least one device and the utility rate information at the desired time of use is retrieved from the memory; and
determine an economical cost to use the at least one device based on the utility service usage information for the at least one device and the cost information for the utility service at various times over the defined time period, wherein the economical cost of use is less than or equal to the total cost of use and wherein the utility service usage information for the at least one device and the utility rate information at the desired time of use is retrieved from the memory.

16. The system of claim 15, further comprising a display, wherein an alternative time of use during the defined time period of the at least one device that corresponds to the economical cost to use the at least one device is displayed on the display.

17. The system of claim 16, wherein the alternative time of use is at a different time during the defined time period than the desired time of use.

18. The system of claim 15, wherein the utility service comprises electricity and the rating comprises electrical consumption information for the at least one device.

19. The system of claim 15, further comprising the processor configured to receive one or more constraints on the time of use of the at least one device and the economical cost to use the at least one device is subject to the one or more constraints on the time of use of the at least one device.

20. The system of claim 19, wherein the one or more constraints on the time of use of the at least one device comprise periods of time during the defined time period when it is desired that the at least one device not be used.
